(19) United States
(12) Patent Application Publication
(10) Pub. No.: US 2024/0173707 A1
(43) Pub. Date: May 30, 2024

(54) METHOD FOR SYNTHESIZING MESOPOROUS NANO-SIZED ZEOLITE BETA

(71) Applicant: Saudi Arabian Oil Company, Dhahran (SA)

(72) Inventors: Lianhui Ding, Dhahran (SA); Khalid Otaibi, Dammam (SA); Faisal Alotaibi, Al Kohbar (SA)

(73) Assignee: Saudi Arabian Oil Company, Dhahran (SA)

(21) Appl. No.: 18/059,722

(22) Filed: Nov. 29, 2022

(51) Int. Cl. B01J 29/70; B01J 35/00; B01J 35/10; B01J 37/00; B01J 37/02; B01J 37/03; B01J 37/04; B01J 37/06; B01J 37/08; C01B 39/48

(52) U.S. Cl. CPC B01J 29/7007; B01J 35/0013; B01J 35/1019; B01J 35/1023; B01J 35/1042; B01J 35/1047; B01J 35/1061; B01J 37/0018; B01J 37/0236; B01J 37/03; B01J 37/04; B01J 37/06; B01J 37/08; C01B 39/48; C01P 2004/03; C01P 2004/64; C01P 2006/12; C01P 2006/14; C01P 2006/16

(57) ABSTRACT

Methods for synthesizing a mesoporous nano-sized zeolite beta are described. The method includes preparing an aqueous hexadecyltrimethylammonium bromide (CTAB) solution and adding nano-sized zeolite particles having a BEA framework type, a particle size of less than or equal to 100 nm, and a microporous framework with a plurality of micropore s having diameters of less than or equal to 2 nm to form a second solution. The second solution does not include a base. The method further includes transferring the second solution to an autoclave operated at 25° C. to 200° C. for 3 to 24 hours to form a colloid; washing the colloid with water to form a washed colloid; drying the washed colloid at 100° C. to 200° C. for 4 to 24 hours to form a zeolite precursor; and calcining the zeolite precursor at 250° C. to 600° C. for 1 to 8 hours to form the mesoporous nano-sized zeolite beta.

### BACKGROUND

### Field

The present disclosure generally relates to nano-sized mesoporous zeolite compositions and the methods of synthesis and use of these compositions, and more specifically, to method for synthesizing a mesoporous nano-sized zeolite beta without base desilication.

### Technical Background

Beta zeolites are crystallized aluminosilicates that are widely used in heavy oil conversion processes such as hydrocracking and fluid catalytic cracking processes. The feedstock to these processes is a portion of the crude oil that has an initial boiling point of 350 Celsius (° C.) and an average molecular weight ranging from about 200 to 600 or greater. Macroporous materials have pores size distributions between 50 and 1000 nanometers (nm). Mesoporous materials have an intermediate pore size distributions, between 2-50 nm. And, microporous materials exhibit pore size distributions in the range of 0.5-2 nm. Conventional beta zeolites have pore sizes (<2 nm) that do not allow the large molecules to diffuse in and to react on the active sites located inside the zeolites. Increasing pore size and reducing particle size of the zeolites are two effective ways to enhance mass transfer and thus greatly improve catalyst performance.

Nano-sized zeolite beta have been generated, but their synthesis has traditionally included processing with a base solution to desilicated a zeolite which requires post-ion exchange to remove residual ions from the base solution. Such post-ion exchange processing decreases yield and thus impedes economic stability of mesoporous zeolite manufacturing.

### BRIEF SUMMARY

Accordingly, there is a clear and long-standing need to provide a solution to synthesizing a mesoporous nano-sized zeolite beta in a more economical manner. The present disclosure addresses such long-standing need by generating mesoporous nano-sized zeolite beta according to a method which allows for desilication with abase solution to be eliminated during zeolite preparation. It will be readily appreciated that elimination of desilication with a base solution improves zeolite yields while concurrently reducing operating costs through fewer process operations.

In accordance with one embodiment of the present disclosure, a method for synthesizing a mesoporous nano-sized zeolite beta includes preparing an aqueous hexadecyltrimethylammonium bromide (CTAB) solution; adding nano-sized zeolite particles having a particle size of less than or equal to 100 nm to the aqueous CTAB solution to form a second solution, wherein the second solution does not include a base and the nano-sized zeolite particles comprise a microporous framework comprising a plurality of micropores having diameters of less than or equal to 2 nm and a BEA framework type; transferring the second solution to an autoclave operated at 25° C. to 200° C. for 3 to 24 hours to form a colloid; washing the colloid with water to form a washed colloid; drying the washed colloid at 100° C. to 200° C. for 4 to 24 hours to form a zeolite precursor; and calcining the zeolite precursor at 250° C. to 600° C. for 1 to 8 hours to form the mesoporous nano-sized zeolite beta.

Additional features and advantages of the technology disclosed herein will be set forth in the detailed description which follows, and in part will be readily apparent to those skilled in the art from that description or recognized by practicing the technology as described herein, including the detailed description which follows, as well as the appended claims.

It is to be understood that both the foregoing general description and the following detailed description present embodiments of the technology, and are intended to provide an overview or framework for understanding the nature and character of the technology as it is claimed. Additionally, following descriptions are meant to be merely illustrative, and are not intended to limit the scope of the claims in any manner.

### DETAILED DESCRIPTION

The present disclosure describes various embodiments related to nano-sized mesoporous zeolite compositions and methods of synthesis of these compositions.

The description may use the phrases “in some embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Zeolite catalysts are commonly used in heavy oil conversion processes such as hydrocracking and fluid catalytic cracking processes. For example, crude oil may passed through hydro-treating and then hydrocracking catalysts to remove undesired contents, such as sulfur, nitrogen, and metals, and convert high molecular weight hydrocarbons (complex aromatics or unsaturated hydrocarbons) into naphtha, kerosene, gasoline, diesel oil or high-quality lubricating oils. The catalyst used in hydroprocessing has two functions: cracking of high molecular weight hydrocarbons and hydrogenating the unsaturated molecules. However, the small pore size of the most widely used zeolites in hydrocracking catalysts (zeolite beta and Y) has a negative impact on the performance of the catalyst by preventing the large molecules in the heavy oil fraction from diffusing into the active sites located inside the zeolites. This leads to decreased activity of the catalysts and a possible deactivation of the catalysts. The poor diffusion efficiency of the large molecules can be mitigated by either increasing the pore size of the zeolite catalysts, or reducing the particle size of the zeolite catalysts, or combining both features. Disclosed here are ordered mesoporous zeolite compositions with average pore size of greater than 3 nm and a particle size of less than 100 nm. Reduction in particle size during the synthesis of the zeolite catalysts impacts the performance of the zeolite catalysts by increasing the external surface area of the catalyst and shortening the diffusion path of the reactants and products.

Previous methods of synthesizing mesoporous nano-sized beta zeolite have generated mesopores by desilication via NaOH or NH₃ and hydrothermal treatment. However, such methods also have traditionally required separation and washing steps after hydrothermal treatment to remove species before calcination of the zeolite. Embodiments in accordance with the present disclosure have developed alternative methods for synthesizing a mesoporous nano-sized zeolite beta without desilication via NaOH or NH₃. Such upgraded synthesis method improves synthesized zeolite yields, reduces operating costs, eliminates handling and disposal of hazardous base solutions, and increases the crystallinity of the resulting zeolite.

Generally described in this disclosure are embodiments of BEA framework type zeolites such as zeolite Beta that may be incorporated into hydrotreating catalysts. The present disclosure relates to methods for producing such zeolites, as well as the properties and structure of the produced zeolites. In some embodiments, the hydrotreating catalysts may be utilized to crack aromatics in heavy oils in a pretreatment process that may take place prior to steam cracking or other downstream processing. According to one or more embodiments, a zeolite composition formed in accordance with the present disclosure may comprise a relatively small particle size and may include mesoporosity Such zeolite materials may be referred to throughout this disclosure as “mesoporous nano-sized zeolite beta.” As used throughout this disclosure, “zeolites” refer to micropore-containing inorganic materials with regular intra-crystalline cavities and channels of molecular dimension. The nicroporous structure of zeolites (for example, 0.3 nm to 1 nm pore size) may render large surface areas and desirable size-/shape-selectivity, which may be advantageous for catalysis. The mesoporous zeolites described may include, for example, aluninosilicates, titanosilicates, or pure silicates. In one or more embodiments, the zeolites described may include micropores (present in the microstructure of a zeolite), and additionally include mesopores. As used throughout this disclosure, micropores refer to pores in a zeolitic structure that have a diameter of less than or equal to 2 nm and greater than or equal to 0.1 nm, and mesopores refer to pores in a zeolitic structure that have a diameter of greater than 2 nm and less than or equal to 50 nm. The zeolite s presently described may be characterized as Beta (that is, having an aluminosilicate BEA framework type).

Disclosed here are specific methods of synthesis of these nano-sized mesoporous zeolite compositions. In accordance with the present disclosure, a method for synthesizing a mesoporous nano-sized zeolite beta preparing an aqueous hexadecyltrimethylammonium bromide (CTAB) solution and adding nano-sized zeolite particles having a particle size of less than or equal to 100 nm to the first solution to form a second solution, wherein the second solution does not include a base and the nano-sized zeolite particles comprise a microporous framework comprising a plurality of micropores having diameters of less than or equal to 2 nm and a BEA framework type. The second solution is transfer to an autoclave operated at 25° C. to 200° C. for 3 to 24 hours to form a colloid. Subsequently, the colloid is washed to form a washed colloid and the washed colloid is dried at 100° C. to 200° C. for 4 to 24 hours to form a zeolite precursor. Finally, the zeolite precursor is calcined at 250° C. to 600° C. for 1 to 8 hours to form the mesoporous nano-sized zeolite beta. It is expressly noted that no base, such as NaOH or NH₄OH, is added as part of the synthesis procedure for desilication of the nano-sized zeolite particles. The method of synthesizing mesoporous nano-sized zeolite beta and each distinct step is discussed in further infra.

In one or more embodiments, an aqueous hexadecyltrimethylammonium bromide solution (CTAB) is formed. Specifically, in one or more embodiments, the CTAB is mixed with water to form up a substantially saturated solution. It is noted that CTAB has a maximum solubility in water of 36.4 grams per liter at 20° C. As such and in view of the CTAB to zeolite mass ratio, as discussed infra, being in the range 0.1 to 1.0, the CTAB solution may be provided at a concentration of 7.25 to 36.4 g/L.

In various embodiments, the aqueous CTAB solution may be mixed for 1 to 30 minutes, 5 to 30 minutes, 5 to 15 minutes, or approximately 10 minutes. It will be appreciated that mixing time is desired to be sufficient to completely dissolve the CTAB into the water to generate the aqueous CTAB solution.

In one or more embodiments, nano-sized zeolite particles are added to the aqueous CTAB solution to form a second solution. The nano-sized zeolite particles may have an average particle size of less than or equal to 100 nm, less than or equal to 90 nm, less than or equal to 85 nm, or less than or equal to 80 nm in various embodiments. Further, the nano-sized zeolite particles comprise a BEA framework type such as zeolite Beta. Additionally, the nano-sized zeolite particles comprise a microporous framework including a plurality of micropores having average diameters of less than or equal to 2 nm. However, it will be appreciated that the nano-sized zeolite particles may also include mesopores.

It will be appreciated that various nano-sized zeolite particles may be utilized, with the methods of the present disclosure increasing the mesoporosity of such nano-sized zeolite particles. In one or more embodiments, the nano-sized zeolite particles may comprise a surface area of 590 m²/g, a pore volume of 0.83 m/g split as a micropore volume of 0.15 m/g and a mesopore volume of 0.68 ml/g, an average pore size of 2.8 nm, and average particle size of 80 nm.

In various embodiments, the second solution may be mixed for 1 to 60 minutes, 5 to 40 minutes, 10 to 30 minutes, or approximately 20 minutes after addition of the nano-sized zeolite particles to the first solution prior to heating the second solution in the autoclave. During mixing of the second solution, the CTAB can form micelles in the second solution with the nano-sized zeolite particles assembling around the micelles. When the CTAB is removed during calcination, mesopores are formed in the voids left by the CTAB.

In various embodiments, the mass ratio of CTAB to nano-sized zeolite particles in the second solution is in the range of 0.1 to 1.0, 0.2 to 0.9, 0.3 to 0.8, 0.4 to 0.8, or approximately 0.7. It will be appreciated that if insufficient CTAB is provided, the CTAB cannot form micelles in the solution such that the nano-sized zeolite beta can assemble around the micelle s, and then form mesopores after calcination. Conversely, if excess CTAB is provided, unnecessary costs and expense is incurred without added benefit.

In one or more embodiments, the second solution is transferred to an autoclave where a colloid is formed. It is noted that within the autoclave the nano-sized zeolite beta is assembled around the micelles formed by CTAB to ultimately form the mesopores.

In various embodiments, the second solution is heated in the autoclave operated at 25° C. to 200° C., 100° C. to 175° C., 120° C. to 160° C., 140° C. to 160° C., or approximately 150° C. Further, in various embodiments, the second solution may be heated in the autoclave for 3 to 24 hours, 4 to 20 hours, 5 to 18 hours, 6 to 14 hours, 8 to 12 hours, or approximately 10 hours. In one or more embodiments, the autoclave is held static in the oven and not rotated.

In one or more embodiments, the autoclave is quenched with water. It will be appreciated that quenching abruptly stops any reaction in the autoclave and ensures the reaction time for all syntheses remain the same across multiple production runs. It will also be appreciated, that the water used to quench the autoclave is not necessarily limited to distilled water and tap or purified water may be utilized as the quenching water does not make contact with contents of the autoclave. In one or more embodiments, the water may be cold water which for purposes of the present disclosure is defined as water at or less than 30° C. In various embodiments, the autoclave may be quenched for 1 hour, 1.5 hours, 2 hours, 3 hours, or 4 hours. In further embodiments, the autoclave may be cooled to room temperature naturally.

In one or more embodiments, the colloid generated from heating in the autoclave is washed with water to form a washed colloid. The water used to wash the zeolite precursor colloid is preferably distilled water to avoid reaction or contamination of the resulting washed colloid. However, it will be appreciated that any purified water without impurities such as Mg, Na, Ca, Cl can be utilized and that distilled water is not required in all embodiments. Such impurities, and especially Mg, Ca, Na cations, can be deposited on the zeolite to neutralize the acidic sites, and thus reduce the zeolite acidity, as well as potentially reduce the zeolite stability. Washing the zeolite precursor colloid removes any free CTAB or other undesirable reaction products from the desired products.

In one or more embodiments, washing the colloid with water to form the washed colloid comprises separating the solid and colloid products from the autoclave from any liquid products formed in the autoclave with a centrifuge. The solid and colloid products are then mixed with the water to wash the solid and colloid products. Water may be added to the solid and colloid products at about a 10:1 weight ratio of water to products and the mixture may be stirred for approximately 30 minutes. The resulting solution is then separated with the centrifuge. In various embodiments, the washing and separation may be repeated for a total of 1, 2, 3, 4, or 5 washings.

In one or more embodiments, the colloid is dried to form a zeolite precursor. In various embodiments, the colloid may be dried at an elevated drying temperature of 100° C. to 200° C., 100° C. to 180° C., 100° C. to 160° C., 110° C. to 150° C., 100° C. to 140° C., 100° C. to 130° C., 100° C. to 120° C., or 100° C. to 110° C. Further, in various embodiments, the washed colloid may be dried at the elevated drying temperature for a period of 4 to 24 hours, 10 to 24 hours, 12 to 24 hours, 6 to 18 hours, 8 to 14 hours, or 8 to 12 hours. Alternatively, the period of drying at the elevated drying temperature may be considered overnight.

In one or more embodiments, the zeolite precursor is calcined to form the mesoporous nano-sized zeolite beta. In various embodiments, the zeolite precursor may be calcined at an elevated calcining temperature of 250° C. to 600° C., 300° C. to 600° C., 400° C. to 600° C., 450° C. to 600° C., 500° C. to 600° C., 550° C. to 600° C., or approximately 550° C. Further, in various embodiments, the zeolite precursor may be calcined at the elevated calcining temperature for a period of 1 to 8 hours, 2 to 6 hours, 3 to 6 hours, 4 to 8 hours, 4 to 5 hours, or approximately 4 hours. In one or more embodiments, the ramp rate during calcining is 2 to 4° C. per minute.

Properties of the mesoporous nano-sized zeolite beta include an average particle size ranging from 10 nm to 100 nm. The average particle size is based on SEM measurement. In some embodiments, the mesoporous nano-sized zeolite beta have a particle size ranging from 10 nm to 90 nm, 20 nm to 100 nm, 30 nm to 100 nm, 40 nm to 100 nm, or 50 nm to 100 nm. The surface area of the mesoporous nano-sized zeolite beta can range from 500 square meters per gram (m²/g) to 800 m²/g. In some embodiments, surface area of the mesoporous nano-sized zeolite pbeta can range from 500 m²/g to 700 m²/g, 550 m²/g to 800 m²/g, 550 m²/g to 700 m²/g, or 600 m²/g to 700 m²/g. The average particle size is based on the Brunauer-Emmett-Teller technique (BET) measurement. The pore volume of the nano-sized zeolite beta can range from 1.0 milliliters per gram (ml/g) to 2.0 ml/g. In some embodiments, the pore volume of the mesoporous nano-sized zeolite beta can range from 1.0 ml/g to 1.8 ml/g, 1.0 ml/g to 1.6 ml/g, 1.0 m/g to 1.5 ml/g, or 1.1 ml/g to 1.4 ml/g. The average pore size of the mesoporous nano-sized zeolite beta can be greater than 3 nm, such as in the range from 3 nm to 50 nm. In some embodiments, the average pore size of the mesoporous nano-sized zeolite beta can range from 2 nm to 40 nm, 5 nm to 30 nm, 5 nm to 50 nm, 5 nm to 30 nm. Alternatively, in various embodiments, the average pore size of the mesoporous nano-sized zeolite beta may be greater than 4 nm, greater than 5 nm, greeter than 6 nm, or greater than 6.5 nm. The pore size may be determined from the surface area and pore volume.

A majority of the pore volume of the mesoporous nano-sized zeolite beta is mesoporous. In various embodiments, at least 60 percent by volume, at least 65 percent by volume, at least 70 percent by volume, at least 75 percent by volume, or at least 80 percent by volume of the pore volume of the mesoporous nano-sized zeolite beta is mesoporous.

Embodiments of the presently disclosed methods for synthesizing a mesoporous nano-sized zeolite beta do not require treating the nano-sized zeolite particles with a base solution. Elimination of such washing step increases yield and reduces operating expenses. Specifically, as one or more steps from a conventional zeolite process are eliminated there is a reduction in operating costs as well as an increase in the synthesized zeolite yields which enhances the economics of mesoporous nano-sized zeolite beta manufacturing.

### EXAMPLES

The methods for synthesizing a mesoporous nano-sized zeolite beta will be further clarified by the following examples. The examples are illustrative in nature, and should not be understood to limit the subject matter of the present disclosure.

Samples of mesoporous nano-sized zeolite beta were prepared to compare synthesis via conventional methods and synthesis in accordance with methods of the present disclosure. The synthesis of mesoporous nano-sized zeolite beta using conventional methods including desilication of the nano-sized zeolite particles with at least one base solution are presented as Comparative Example 2, Comparative Example 4, and Comparative Example 5. The synthesis of mesoporous nano-sized zeolite beta omitting all base solutions are presented as Inventive Example 1 and Inventive Example 3.

### Inventive Example 1

Mesoporous nano-sized zeolite beta was prepared without inclusion of any base to assist with desiliction in accordance with Inventive Example 1. In a first vessel, 2.265 grams of CTAB from Sigma Aldrich was added to 62.5 grams of H₂O and the resulting aqueous CTAB solution was stirred for 10 minutes. The water is purified water with Reverse Osmosis (RO) water purification technology. After mixing, 4.56 grams of nano-beta zeolite (3.24 grams on a dry based) was added to the aqueous CTAB solution and stirred for 20 minutes to form a second solution. The nano-sized zeolite beta was the nano-sized zeolite beta disclosed in L. Ding, et al. Microporous and Mesoporous Materials 94 (2006) 1-8. The second solution was subsequently transferred into a PTFE lined stainless steel autoclave, sealed, and heated. The autoclave was operated at 150° C. for ten hours and subsequently quenched with water. The colloid formed in the autoclave was then washed in a high-speed centrifuge two times. The solid zeolite products were then dried at 110° C. overnight, and calcined at 550° C. for 4 hours at a ramp of 2° C. per minute.

### Comparative Example 2

Mesoporous nano-sized zeolite beta was prepared with NH₃ added to desilicated the nano-beta zeolite for Comparative Example 2. In a first vessel, 2.265 grams of CTAB from Sigma Aldrich was added to 62.5 grams of 0.5M NH₃·H₂O from Sigma Aldrich and the resulting first solution was stirred for 10 minutes. The water is purified water with Reverse Osmosis (RO) water purification technology. After mixing, 4.56 grams of nano-beta zeolite (3.24 grams on a dry based) was added to the first solution and stirred for 20 minutes to form a second solution. It is noted that the nano-beta zeolite was the same nano-beta zeolite utilized for Inventive Example 1. The second solution was subsequently transferred into a PTFE lined stainless steel autoclave, sealed, and heated. The autoclave was operated at 150° C. for ten hours and subsequently quenched with water. The colloid formed in the autoclave was then washed in a high-speed centrifuge three times. The solid zeolite products were then dried at 110° C. overnight, and calcined at 550° C. for 4 hours at a ramp of 2° C. per rninute.

The synthesis parameters of Inventive Example 1 and Comparative Example 2 are presented below in Table 1. It is noted that the zeolite contains about 29% of water. As such, in the calculation of the CTAB to Zeolite ratio where the zeolite is on a dry basis the moisture must be accounted for. Specifically, the 4.56 grams of zeolite includes 3.24 grams dry based zeolite resulting in the presented CTAB to Zeolite weight ratio of 0.7.

TABLE 1
Synthesis Parameters of Inventive
Example 1 and Comparative Example 2

| | Inventive | Comparative |
|---|---|---|
| | Example 1 | Example 2 |
| Base Type | — | 0.5M |
| | | NH₃•H₂O |
| CTAB to Zeolite ratio | 0.7 | 0.7 |
| (weight:weight) | | |
| Components | | |
| Zeolite, g | 4.56 | 4.56 |
| Zeolite (dry basis), g | 3.24 | 3.24 |
| Water, ml | 62.5 | 0 |
| NH₃•H₂O (0.5M) , ml | 0 | 62.5 |
| CTAB, g | 2.265 | 2.265 |
| Autoclave Processing | | |
| Temperature, ° C. | 150 | 150 |
| Time, hour | 10 | 10 |

### Comparative Example 3

Mesoporous nano-sized zeolite beta was prepared with NaOH added to desilicated the nano-beta zeolite for Comparative Example 3. In a first vessel, 2.265 grams of CTAB from Sigma Aldrich was added to 62.5 grams of 0.5M NaOH from Sigma Aldrich and the resulting first solution was stirred for 10 minutes. After mixing, 4.56 grams of nano-beta zeolite (3.24 grams on a dry based) was added to the first solution and stirred for 20 minutes to form a second solution. It is noted that the nano-beta zeolite was the same nano-beta zeolite utilized for Inventive Example 1. The second solution was subsequently transferred into a PTFE lined stainless steel autoclave, sealed, and heated. The autoclave was operated at 150° C. for ten hours and subsequently quenched with water. The colloid formed in the autoclave was then washed in a high-speed centrifuge three times. The solid zeolite products were then dried at 110° C. overnight, and calcined at 550° C. for 4 hours at a ramp of 2° C. per minute.

### Comparative Example 4

Mesoporous nano-sized zeolite beta was prepared with NaOH added to desilicated the nano-beta zeolite for Comparative Example 4. In a first vessel, 2.265 grams of CTAB from Sigma Aldrich was added to 62.5 grams of 0.33M NaOH from Sigma Aldrich and the resulting first solution was stirred for 10 minutes. After mixing, 4.56 grams of nano-beta zeolite (3.24 grams on a dry based) was added to the first solution and stirred for 20 minutes to form a second solution. It is noted that the nano-beta zeolite was the same nano-beta zeolite utilized for Inventive Example 1. The second solution was subsequently transferred into a PTFE lined stainless steel autoclave, sealed, and heated. The autoclave was operated at 150° C. for ten hours and subsequently quenched with water. The colloid formed in the autoclave was then washed in a high-speed centrifuge three times. The solid zeolite products were then dried at 110° C. overnight, and calcined at 550° C. for 4 hours at a ramp of 2° C. per minute.

The synthesis parameters of Inventive Example 3, Comparative Example 4, and Comparative Example 5 are presented below in Table 2.

TABLE 2
Synthesis Parameters of Inventive Example
3 and Comparative Examples 3 and 4

| | Inventive | Comparative | Comparative |
|---|---|---|---|
| | Example 1 | Example 3 | Example 4 |
| Base Type | — | 0.5M NaOH | 0.33M NaOH |
| CTAB to Zeolite ratio | 0.7 | 0.7 | 0.7 |
| (weight:weight) | | | |
| Components | | | |
| Zeolite, g | 4.56 | 4.56 | 4.56 |
| Zeolite (dry basis), g | 3.24 | 3.24 | 3.24 |
| Water, ml | 62.5 | 0 | 0 |
| NaOH (0.5M) , ml | 0 | 62.5 | 0 |
| NaOH (0.33M) , ml | 0 | 0 | 62.5 |
| CTAB, g | 2.265 | 2.265 | 2.265 |
| Autoclave Processing | | | |
| Temperature, ° C. | 150 | 150 | 150 |
| Time, hour | 10 | 10 | 10 |

The properties of the mesoporous nano-size zeolite beta of Inventive Example 1 and Comparative Example 2 are presented below in Table 3. Similarly, properties of the mesoporous nano-size zeolite beta of Inventive Example 3, Comparative Example 4, and Comparative Example 5 are presented below in Table 4. The average particle size is based on SEM measurement. The average pore sizes were determined from the surface area using Brunauer-Emmett-Teller (BET) technique and pore volume. The XRD crystallinity was determined with CP-814E (Zeolyst International) used as the reference.

TABLE 3
Mesoporous Nano-Sized Zeolite Beta Properties

| | Inventive | Comparative | Comparative | Comparative |
|---|---|---|---|---|
| | Example 1 | Example 2 | Example 3 | Example 4 |
| Surface area, | 647 | 659 | 629 | 625 |
| m²/g | | | | |
| Micropore | 357 | 399 | 337 | 329 |
| Mesopore | 290 | 260 | 291 | 296 |
| Pore Volume, | 1.38 | 1.29 | 1.14 | 1.12 |
| m²/g | | | | |
| Micropore | 0.19 | 0.22 | 0.172 | 0.165 |
| Mesopore | 1.19 | 1.07 | 0.96 | 0.96 |
| Average pore | 8.50 | 7.80 | 7.20 | 7.17 |
| size, nm | | | | |
| XRD Phase | Beta | Beta | Beta | Beta |
| Crystallinity, % | 98% | 96% | 81% | 81% |

As shown in Tables 3 and 4, the zeolites prepared via conventional synthesis methods with desilication with a base (Comparative Example 2, Comparative Example 4, and Comparative Example 5) were similar to the zeolites prepared via the methods in accordance with the present disclosure where no base assisted desilication was completed (Inventive Example 1 and Inventive Example 3). Specifically, comparison of Inventive Example 1 and Comparative Example 2 illustrates that omission of the base solution for desilication still achieved a desirable zeolite product. Similarly, comparison of Inventive Example 3 and Comparative Examples 4 and 5 illustrates that omission of the base solution for desilication still achieved a desirable zeolite product. As such, it is demonstrated that in accordance with the methods of the present disclosure, desilication with a base present during preparation of zeolites is not necessary and may be omitted to generate mesoporous nano-sized zeolite beta in accordance with the processes of the present disclosure.

Based on the foregoing, it should now be understood that various aspects of method and systems for producing aromatics and light olefins from a mixed plastics stream are disclosed herein.

According to a first aspect of the present disclosure, a method for synthesizing a mesoporous nano-sized zeolite beta comprises preparing an aqueous hexadecyltrimethylammonium bromide (CTAB) solution; adding nano-sized zeolite particles having a particle size of less than or equal to 100 nm to the aqueous CTAB solution to form a second solution, wherein the second solution does not include a base and the nano-sized zeolite particles comprise a microporous framework comprising a plurality of micropores having diameters of less than or equal to 2 nm and a BEA framework type; transferring the second solution to an autoclave operated at 25° C. to 200° C. for 3 to 24 hours to form a colloid; washing the colloid with water to form a washed colloid; drying the washed colloid at 100° C. to 200° C. for 4 to 24 hours to form a zeolite precursor; and calcining the zeolite precursor at 250° C. to 600° C. for 1 to 8 hours to form the mesoporous nano-sized zeolite beta.

A second aspect includes the method of the first aspect, in which the mesoporous nano-sized zeolite beta comprises an average particle size, based on SEM measurement, of 10 to 100 nanometers.

A third aspect includes the method of the first or second aspects, in which the mesoporous nano-sized zeolite beta comprises a surface area, based on BET measurement, of 500 to 800 m²/g.

A fourth aspect includes the method of any of the first through third aspects, in which the mesoporous nano-sized zeolite beta comprises a pore volume of 1.0 to 2.0 ml/g.

A fifth aspect includes the method of any of the first through fourth aspects, in which at least 60 percent by volume of the pore volume is mesoporous.

A sixth aspect includes the method of any of the first through fifth aspects, in which the mesoporous nano-sized zeolite beta comprises an average pore size of greater than 3 nm.

A seventh aspect includes the method of any of the first through sixth aspects, in which the mass ratio of CTAB to nano-sized zeolite particles in the second solution is in the range of 0.1 to 1.0.

An eighth includes the method of any of the first through seventh aspects, in which the aqueous CTAB solution is mixed for 1 to 30 minutes prior to adding the nano-sized zeolite particles to form the second solution.

A ninth aspect includes the method of any of the first through eighth aspects, in which the second solution is mixed for 1 to 60 minutes prior to heating the second solution in the autoclave.

A tenth aspect includes the method of any of the first through ninth aspects, in which the autoclave is operated at 140° C. to 160° C. for 8 to 12 hours.

An eleventh aspect includes the method of any of the first through tenth aspects, in which washing the colloid with water to form the washed colloid is completed in a centrifuge.

A twelfth aspect includes the method of any of the first through eleventh aspects, in which the washed colloid is dried at 100° C. to 120° C. for 8 to 12 hours.

A thirteenth aspect includes the method of any of the first through twelfth aspects, in which the zeolite precursor is calcined at 550° C. to 600° C. for 3 to 6 hours to form the mesoporous nano-sized zeolite beta.

A fourteenth aspect includes the method of any of the first through thirteenth aspects, in which the ramp rate during calcining is 2 to 4° C. per minute.

It should be apparent to those skilled in the art that various modifications and variations can be made to the described embodiments without departing from the spirit and scope of the claimed subject matter. Thus, it is intended that the specification cover the modifications and variations of the various described embodiments provided such modifications and variations come within the scope of the appended claims and their equivalents.

The singular forms “a”, “an” and “the” include plural referents, unless the context clearly dictates otherwise.

Throughout this disclosure ranges are provided. It is envisioned that each discrete value encompassed by the ranges are also included. Additionally, the ranges which may be formed by each discrete value encompassed by the explicitly disclosed ranges are equally envisioned. For brevity, the same is not explicitly indicated subsequent to each disclosed range and the present general indication is provided. Further, it should be understood that any two quantitative values assigned to a property may constitute a range of that property, and all combinations of ranges formed from all stated quantitative values of a given property are contemplated in this disclosure.

As used in this disclosure and in the appended claims, the words “comprise,” “has,” and “include” and all grammatical variations thereof are each intended to have an open, non-limiting meaning that does not exclude additional elements or steps.

Throughout the present description, numerous details are set forth in order to provide a thorough understanding of the various embodiments. In other instances, well-known processes, devices, and systems may not been described in particular detail in order not to unnecessarily obscure the various embodiments, but such would be obtainable by one skilled in the art. Additionally, illustrations of the various embodiments may omit certain features or details in order to not obscure the various embodiments.

What is claimed is:

1. A method for synthesizing a mesoporous nano-sized zeolite beta, the method comprising:
preparing an aqueous hexadecyltrimethylammonium bromide (CTAB) solution;
adding nano-sized zeolite particles having a particle size of less than or equal to 100 nm to the aqueous CTAB solution to form a second solution, wherein the second solution does not include abase and the nano-sized zeolite particles comprise a microporous framework comprising a plurality of micropores having diameters of less than or equal to 2 nm and a BEA framework type;
transferring the second solution to an autoclave operated at 25° C. to 200° C. for 3 to 24 hours to form a colloid;
washing the colloid with water to form a washed colloid;
drying the washed colloid at 100° C. to 200° C. for 4 to 24 hours to form a zeolite precursor; and
calcining the zeolite precursor at 250° C. to 600° C. for 1 to 8 hours to form the mesoporous nano-sized zeolite beta.

2. The method of claim 1, wherein the mesoporous nano-sized zeolite beta comprises an average particle size, based on SEM measurement, of 10 to 100 nanometers.

3. The method of claim 1, wherein the mesoporous nano-sized zeolite beta comprises a surface area, based on BET measurement, of 500 to 800 m²/g.

4. The method of claim 1, wherein the mesoporous nano-sized zeolite beta comprises a pore volume of 1.0 to 2.0 ml/g.

5. The method of claim 4, wherein at least 60 percent by volume of the pore volume is mesoporous.

6. The method of claim 1, wherein the mesoporous nano-sized zeolite beta comprises an average pore size of greater than 3 nm.

7. The method of claim 1, wherein the mass ratio of CTAB to nano-sized zeolite particles in the second solution is in the range of 0.1 to 1.0.

8. The method of claim 1, wherein the aqueous CTAB solution is mixed for 1 to 30 minutes prior to adding the nano-sized zeolite particles to form the second solution.

9. The method of claim 1, wherein the second solution is mixed for 1 to 60 minutes prior to heating the second solution in the autoclave.

10. The method of claim 1, wherein the autoclave is operated at 140° C. to 160° C. for 8 to 12 hours.

11. The method of claim 1, wherein washing the colloid with water to form the washed colloid is completed in a centrifuge.

12. The method of claim 1, wherein the washed colloid is dried at 100° C. to 120° C. for 8 to 12 hours.

13. The method of claim 1, wherein the zeolite precursor is calcined at 550° C. to 600° C. for 3 to 6 hours to form the mesoporous nano-sized zeolite beta.

14. The method of claim 1, wherein the ramp rate during calcining is 2 to 4° C. per minute.
